(19) United States
(12) Patent Application Publication
(10) Pub. No.: US 2007/0041603 A1
(43) Pub. Date: Feb. 22, 2007

(54) Correction-fluid container stylized novelty device

(76) Inventor: Dan R. Stingley, Clearwater, FL (US)

Correspondence Address: Dan R. Stingley, 411 Cleveland St. #193, Clearwater, FL, 33755, US

(21) Appl. No.: 11/507,632

(22) Filed: Aug. 21, 2006

Related U.S. Application Data
(60) Provisional application No. 60/710,172, filed on Aug. 22, 2005.

(51) Int. Cl. H04R 1/02; H04R 9/06

(52) U.S. Cl. 381/334

(57) ABSTRACT

A novelty device that includes a bottle that is configured to convey an overall visual impression of a conventional correction fluid bottle that is exaggerated in shaped and/or size, a cap that is configured to esthetically and functionally corporate with the bottle, and indicia disposed upon the bottle, the indicia comprising textual and/or graphics that in combination with the overall visual impression of the bottle convey the impression of a conventional correction fluid bottle, the textual indicia at least in part comprising humorously ironic words that invoke a humorous response based directly or indirectly on the general concept of correcting or covering up a problem, mistake, and/or issue. In some implementations, the cap has an embedded audio playback device operable to play and record an audio message, the embedded audio playback device comprising buttons and/or indicators configured to be accessible from the top of the cap

### CROSS-REFERENCE TO RELATED APPLICATIONS

The present Utility patent application claims priority benefit of the U.S. provisional application for patent 60/710,172 filed on Aug. 22, 2005 under 35 U.S.C. 119(e).

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to novelty devices. More particularly, the invention relates to novelty devices that are stylized to appear like a correction-fluid container optionally having various indicia and/or audio capabilities to enhance the humorous effect of the novelty device.

### BACKGROUND OF THE INVENTION

The present invention addresses the need of providing a novelty device that represents the practice of discretely covering up mistakes or wrong-doing, but in an ironic, humorous way that is based on a liquid correction fluid concept that is conventionally not associated therewith.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a front view of an exemplary novelty product, in accordance with an embodiment of the present invention;

FIG. 2 illustrates a rear view of the novelty product that includes an exemplary label with indicia, in accordance with an embodiment of the present invention;

FIG. 3 illustrates an exemplary top view of the cap of the novelty product, which includes a sound recording device, in accordance with an embodiment of the present invention; and

FIG. 4 illustrates an exemplary vertical cross-sectional view of the novelty product.

Unless otherwise indicated illustrations in the figures are not necessarily drawn to scale.

### SUMMARY OF THE INVENTION

To achieve the forgoing and other objects and in accordance with the purpose of the invention, a novelty device is described that is stylized to appear like a correction-fluid container and to provide a humorous effect.

In one embodiment of the present invention, a novelty device is proved that includes a bottle that is configured to convey an overall visual impression of a conventional correction fluid bottle that is exaggerated in shaped and/or size, a cap that is configured to esthetically and functionally corporate with the bottle, and indicia disposed upon the bottle, the indicia comprising textual and/or graphics that in combination with the overall visual impression of the bottle convey the impression of a conventional correction fluid bottle, the textual indicia at least in part comprising humorously ironic words that invoke a humorous response based directly or indirectly on the general concept of correcting or covering up a problem, mistake, and/or issue.

In some embodiments, the cap has an embedded audio playback device operable to play and record an audio message, the embedded audio playback device comprising buttons and/or indicators configured to be accessible from the top of the cap.

In yet other embodiments of the present invention, a novelty device is configured to be inflatable.

Means are also provided in alternative embodiments of the present invention to implement some or all of the forgoing functions.

Other features, advantages, and object of the present invention will become more apparent and be more readily understood from the following detailed description,. which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognized a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternatives embodiments do not necessarily imply that the two are mutually exclusive.

It is to be understood that any exact measurements/dimensions or particular construction materials indicated herein are solely provided as examples of suitable configurations and are not intended to be limiting in any way. Depending on the needs of the particular application, those skilled in the are will readily recognize, the light of the following teachings, a multiplicity of suitable alternative implementation details.

One aspect of the present invention is to create a stylized version of a conventional correction fluid bottle that is commonly used to white out written errors on paper. The intent of the preferred embodiment of the present invention is to initially appear as a conventional, well known correction fluid bottle, but upon close inspection, one will see that is it indeed a joke or novelty product. Given that a standard size correction fluid or liquid correction fluid bottle reminds most people of a product they have used to cover up a mistake on paper, an exaggerated version thereof tends to make recipients of the present novelty device to think of big problem or big mistake in judgment. In this way, the present invention provides a product that offers the recipient a pneumonic device that encourages laughter at one's own mistakes, instead of feeling bad about them. The preferred embodiment is further configured to include a conventional audio device that is capable of the recording and playback of personalized messages, which is intended to further enhance impact communicated by the product. However, alternative embodiments of the present invention may not include the audio capability.

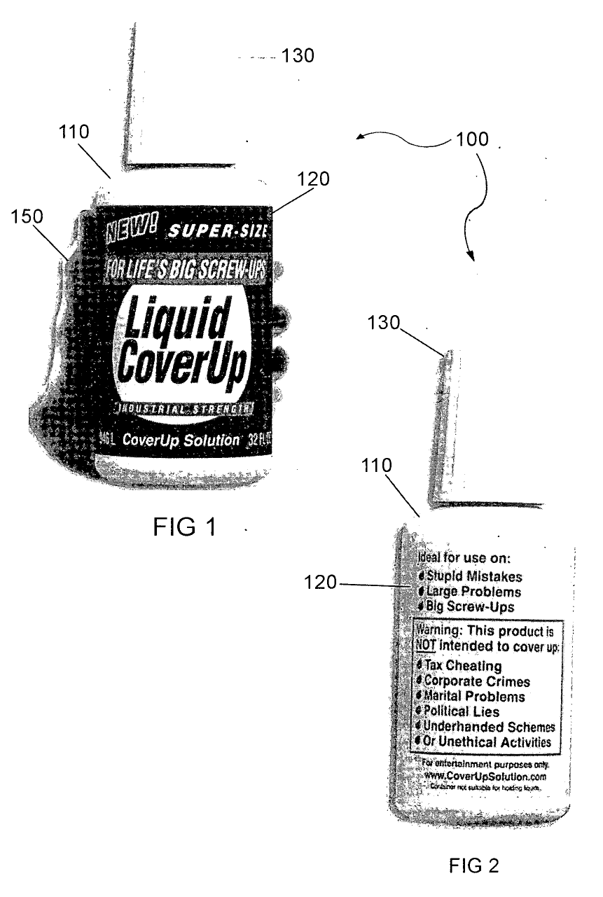

FIG. 1 illustrates a front view of an exemplary novelty correction fluid product 100 that is stylized to appear like a correction-fluid container, in accordance with an embodiment of the present invention. Novelty product 100 is comprised of a bottle shaped container portion 110, which is covered by some kind of conventional labeling 120. Labeling 120 preferably is designed with indicia and imagery that in combination with the shape and design of bottle 110 convey the impression of a conventional correction fluid bottle that is commonly used to white out written errors on paper. A bottle cap 130 is configured to appear as a conventional bottle cap for the correction fluid bottle. In some embodiments bottle cap 130 is configured to be removably joined to bottle 110, and in other embodiments it is not removable, depending upon the needs of the particular application.

In the present embodiment, novelty product 100 is exaggerated in size to be much larger that expected. A normal person's hand 150 is shown gripping the novelty product 100 to show the relative size of the product; however, hand 150 is not intended to be part of the present embodiment. The present embodiment is sized to be about 50 times larger in capacity than the familiar looking standard correction fluid bottle, or about 32 fluid ounces, as compared to the standard 0.7 fluid ounce bottle of correct fluid. Hence, the present embodiment, bottle 110 is about 10″ tall, including cap, and is 3.5″ wide, and cap 130 is about 3.25″ high. However, in other embodiments, an exaggerated bottle that is twice normal size may still impart the desired effect. Again, the larger bottle size is contemplated to cause someone seeing it to think of big mistakes or big problems. It is further contemplated, that those skilled in the art, in light of the present invention, will readily recognize a multiplicity of alternative and suitable approaches to implementing exaggerated, stylized features that convey a humorous twist on the concept correction or covering up a problem, mistake, or issue.

FIG. 2 illustrates a rear view of the novelty product that includes an exemplary label with indicia, in accordance with an embodiment of the present invention. The wording or images on the front or back of label 120 is shown in the figure by way of example, and it is likewise contemplated that those skilled in the art, in light of the present invention, will readily recognize a multiplicity of alternative and suitable humorously ironic words and/or images and/or sounds that invoke a humorous response based directly or indirectly on the concept correction or covering up a problem, mistake, or issue.

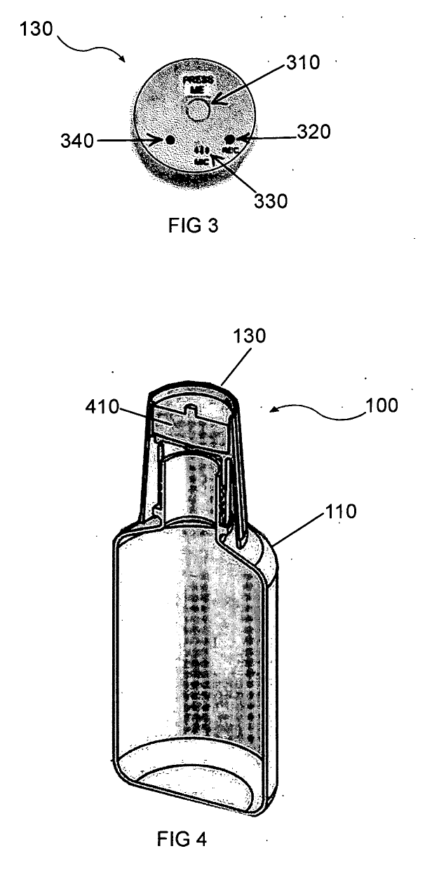

FIG. 3 illustrates an exemplary top view of cap 130, which includes an embedded sound recording device (not shown), in accordance with an audio enabled embodiment of the present invention. The present embodiment shown of cap 130 comprises audio capabilities to enhance the humorous effect of the novelty device. Cap 130 is configured with an audio device that preferably has “record” and “play” functions, both of which may be activated manually by pressing the record and play buttons located on the top of the cap.

A playback button 310 (indicated to the user by way of example with “Press Me”) is provided to play recorded messages in the embedded audio device. A record button 320 is proved to initiate the recording of an audio message by the embedded audio device. A microphone 330 is used to detect the audio signals to be recorded. A recording light 340 lights when the record button is activated and the embedded audio device is recording of the audio message. In the present embodiment, casing of the sound device is 1.75″ in diameter and 11/16″ in depth, but any suitable dimensions may be implemented. A conventional speaker (not shown) may be embedded in any suitable location either within the cap or the bottle. In the preferred embodiment, the speaker is located in the cap and able to broadcast the playback sound out the top of the cap as well as the bottom of the cap, resulting in an easy to hear sound during playback.

Alternate embodiments of the present invention may include only a playback capability of standard prerecorded messages. Some alternate embodiments may have no audio capability at all. Depending upon the needs of the particular application, yet other alternate embodiments may be configured with a multiplicity of conventional triggering mechanisms used to trigger the playing of (potentially randomized) audio messages by various known triggering methods known to those skilled; e.g., including, without limitation, detection of a certain threshold and/or pattern of sound, light, and/or motion. Such embodiment may not have playback or record buttons if not needed for the particular application.

The embedded audio device is contemplated to be a digital recording device, however, it may be implemented as any suitable conventional recording device configured to properly operate for the intended application and purpose. Some additional standard features contemplated include, but are not limited to, storing messages or memos (e.g., up to 15 seconds), play audio messages back up to 500 times on one set of batteries, etc. It is contemplated that the memo function could be a practical usage of said novelty device, especially on the desk in an office environment.

FIG. 4 illustrates an exemplary vertical cross-sectional view of novelty device 100. Cap 130 is shown to comprise an embedded audio device 410. Bottle portion 110 is preferably empty and cap 130 is preferably removable so as to enable the storage of common items (e.g., change, pens, pencils or other small loose items one may wish to store) inside the bottle. In the present embodiment, novelty device 100 is not designed, however, to store liquids inside, as the cap contains the embedded electronic recorder device, which could be damaged by such liquids. It is contemplated that those skilled in the art, using conventional techniques can waterproof the sensitive electronics in the cap, and, thereby, enable the safe storage of liquids inside the bottle.

The structural parts of the foregoing embodiments are made of plastic, however any suitable materials may be used as dictated by the needs of the application.

As indicated above, a multiplicity of alternative means, according to alternative embodiments of the present invention, are contemplated to humorously exaggerate the appearance of a correction-fluid container according to the spirit of the present invention. By way of further example, and not limitation, one such alternative embodiment is a very large inflatable version; e.g., without limitation, 20-25 gallon in size), which would be about 5,000 times bigger than the standard 0.7 oz size correction-fluid container, however any desired larger size (e.g., versions could range from twice the normal size, to well over 5,000 times bigger that a standard correction-fluid container) could be implemented depending upon the needs of the particular application. The present inflatable embodiment example would be approximately 3 to 4 feet in height and would be able to sit in an office chair to possible indicate that a “very, very BIG” mistake had been made by someone, or in preparation to cover up any future problems. The inflatable embodiment may include any combination, or none, of the forgoing design options provided for the other embodiments described; e.g., without limitation, with or without sound, etc.

Again, those skilled in the art, in accordance with the teachings of the present invention, will readily recognize a multiplicity of alternative suitable size, shape, constructions materials, and visual indicia/impressions in the implementation of inflatable, or any alternative, embodiments as dictated by the needs of the particular application. For example, inflatable embodiments may be configured to be bottom heavy with a restoring force such that they cannot be knocked over (like floor standing inflatable punching bag) and may additionally be configured with a sound playback feature that is triggered, for example, by the inflated novelty device being suddenly moved (e.g., being punched), whereby some humorous audio message might be played; e.g., possibly with the intent of invoking a humorous response from the user based directly or indirectly on the concept of correcting or covering up a problem, mistake, and/or issue.

Having fully described at least one embodiment or the present invention, other equivalent or alternative methods of implementing novelty devices that are stylized to appear like a correction-fluid container and provide a humorous effect according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A novelty device comprising:
a bottle that is configured to convey an overall visual impression of a convention correction fluid bottle that is exaggerated in shaped and/or size;
a cap that is configured to esthetically and functionally corporate with said bottle; and
indicia disposed upon said bottle, said indicia comprising textual and/or graphics that in combination with said overall visual impression of said bottle convey the impression of a conventional correction fluid bottle, said textual indicia at least in part comprising humorously ironic words that invoke a humorous response based directly or indirectly on the general concept of correcting or covering up a problem, mistake, and/or issue.

2. The novelty product of claim 1, in which said cap comprises:
an embedded audio playback device operable to play a prerecorded audio message through a speaker; and
buttons and/or indicators associated with the proper operation of said audio playback device.

3. The novelty product of claim 1, in which said cap comprises:
an embedded audio device operable to play and record an audio message through a speaker;
buttons and/or indicators associated with the proper operation of said audio device; and
a microphone use to detect audio signals that are recorded by said audio device.

4. The novelty product of claim 2, in which said speaker is configured to project the playback sound out of the top and bottom of said cap, thereby enhancing the sound quality.

5. The novelty product of claim 3, in which said speaker is configured to project the playback sound out of the top and bottom of said cap, thereby enhancing the sound quality.

6. The novelty product of claim 3, in which said embedded audio device is a digital device, and said microphone is disposed at the top of said cap, and is operable to properly record audio signals that are projected onto the top of said cap.

7. The novelty product of claim 1, in which said cap is configured to be removably joined to said bottle.

8. The novelty product of claim 1, in which said bottle is hollow and operable to store small items that can fit therein.

9. The novelty product of claim 1, in which said bottle and cap are exaggerated by proportionately increasing their size to be at least two times greater than normal.

10. The novelty product of claim 1, in which said bottle and cap are exaggerated by proportionately increasing their size to be about 50 times greater than normal.

11. The novelty product of claim 1, in which said cap is sized with a height that is about one third the overall height of said novelty product.

12. The novelty product of claim 1, in which said bottle and cap are constructed to be inflatable.

13. The novelty product of claim 12, in which said bottle and cap are exaggerated by proportionately increasing their size to be greater than 50 times normal size.

14. A novelty device comprising:
a bottle that is configured with means to exaggerate an overall visual impression of a conventional correction fluid bottle;
means for capping said exaggerated correction fluid bottle; and
means for configuring indicia disposed upon said bottle to convey the impression of a conventional correction fluid bottle and invoking a humorous response based directly or indirectly on the general concept of correcting or covering up a problem, mistake, and/or issue.

15. The novelty product of claim 14, in which said cap means comprises means for playing a prerecorded audio message.

16. The novelty product of claim 14, in which said cap means comprises means for playing and/or recording an audio messages.

17. The novelty product of claim 15, in which said audio playing means comprises a speaker that is configured to project the playback sound out of the top and bottom of said cap, thereby enhancing the sound quality.

18. The novelty product of claim 16, in which said audio playing/recording means comprises a speaker that is configured to project the playback sound out of the top and bottom of said cap, thereby enhancing the sound quality.

19. The novelty product of claim 14, in which said bottle and cap means are constructed to be inflatable.

20. A novelty device comprising:
a bottle that is configured to convey an overall visual impression of a conventional correction fluid bottle that is exaggerated in shaped and/or size;
a cap that is configured to esthetically and functionally corporate with said bottle, said cap being further configured with an embedded audio playback device operable to play and record an audio message, said embedded audio playback device comprising buttons and/or indicators configured to be accessible from the top of said cap; and
indicia disposed upon said bottle, said indicia comprising textual and/or graphics that in combination with said overall visual impression of said bottle convey the impression of a conventional correction fluid bottle, said textual indicia at least in part comprising humorously ironic words that invoke a humorous response based directly or indirectly on the general concept of correcting or covering up a problem, mistake, and/or issue.
